(19) United States
(12) Patent Application Publication
(10) Pub. No.: US 2010/0284330 A1
(43) Pub. Date: Nov. 11, 2010

(54) Radio Telecommunications Network Node and Method of Adjusting Routing Table Up-date Interval

(76) Inventor: Yangcheng Huang, Athlone (IE)

Correspondence Address: POTOMAC PATENT GROUP PLLC, P. O. BOX 270, FREDERICKSBURG, VA, 22404, US

(21) Appl. No.: 12/681,769

(22) PCT Filed: Oct. 16, 2007
(86) PCT No.: PCT/EP07/61000

§ 371 Date: Jul. 19, 2010

(51) Int. Cl. H04W 40/00

(52) U.S. Cl. 370/328

(57) ABSTRACT

A method of adjusting a routing table update interval in a node of an ad-hoc radio telecommunications network comprising: reducing the routing table update interval by dividing it by a first constant value if a local change in the network is detected by the node. If a remote change in the network is detected by the node a rate of routing table exchange is increased by a second constant value. If no network change is detected by the node the rate of routing table exchange is reduced by the second constant value, wherein the rate of routing table exchange is reciprocal of the routing table update interval.

### TECHNICAL FIELD

The present invention relates to ad-hoc radio telecommunications networks, in general, and in particular to method of adjusting time interval of a routing table update of a node in such an ad-hoc radio telecommunications networks.

### BACKGROUND

Wireless mesh networks (WMNs) are multi-hop infrastructure-less networks characterized by dynamic self-organization, self-configuration and self-healing. These factors allow WMNs to support fast, reliable and cost-effective network deployment in very diverse environments and provide better coverage and capacity to stationary and mobile users. Correspondingly, WMNs can host a wide range of applications in military, disaster recovery, commercial and private settings. One typical example is Ericsson Response program, in which WMN infrastructure is used to enhance robustness and quick deployment of transportable cellular networks. This solution provides effective and robust services in disaster rescue and other mission-critical scenarios.

Destination Sequenced Distance-Vector Routing protocol (DSDV) is a table-driven proactive routing algorithm based on the classical Bellman-Ford routing mechanism. Each node in the network maintains a routing table that records distance vectors, i.e. the number of hops to all of the possible destinations within the network and the corresponding next-hop nodes. Depending on the number of route change occurrences, a DSDV node sends periodically or by triggers the routing table to the neighbouring nodes.

There are two problems with the existing DSDV protocols, and these include slow convergence speed, and route churn.

In DSDV link changes are propagated hop-by-hop by exchanging routing tables between neighbouring nodes. This significantly reduces the volume of control traffic overhead. However, one major concern about this mechanism is its slow convergence in the presence of link changes—let r be the routing table update interval and d be the distance to a remote node (i.e. a number of hops). It takes a maximal period of r*d for a link change to be propagated to a remote node that is d hops away.

Due to the lack of central management of mesh networks, link breaks or link quality changes in mesh networks are not rare events. In such environment distance-vector routing converges much slower than link-state routing and can potentially degrade network stability.

DSDV uses a time-out mechanism when removing stale routes. Route entries are removed if there are no route updates received within a period. With an increase of network size, it takes longer for the route updates to be propagated to each node in the network, especially for the edge nodes. Therefore, even if all the network nodes are stationary, the routing table of the edge nodes would slowly “churn” as routes are constructed to distant nodes and then timeout before any routing table updates arrive. Thus valid route entries might be falsely removed.

A smaller routing table update interval allows nodes to adapt faster to any network changes. Therefore, one common approach in tackling the problem of slow convergence is the use of a smaller routing table update interval, which could reduce the convergence latency.

There are two major problems with this approach. A smaller topology update interval means a higher topology update frequency. Therefore this approach introduces too much control overhead. Another problem is that a small interval makes the problem of route chum even worse. In a relatively stable network where not all the nodes are in mobility or in changes a smaller interval could lead to route expiration and false removal in the stable nodes.

To summarize, although in DSDV reducing routing table update intervals improve route convergence speed, the improvement is at the cost of excessive control overhead and route churn.

In an alternative, known solution called Adaptive Distance Vector (ADV) routing algorithm the frequency of topology update is adjusted according to network conditions. Compared to DSDV, ADV has some improvements. ADV exchanges route updates between the neighbouring nodes, but only route entries of active nodes are advertised, which reduces the size of route update messages. In ADV, route updates are triggered in an on-demand way. The trigger requests are from neighbouring nodes. A route update is triggered if the neighbouring nodes have data packets to deliver or the neighbouring nodes suffer from link changes.

ADV, however, has also some problems. Since it is triggered by network events, the route update frequency might increase quickly with the node mobility, which leads to larger control overhead than periodic update in DSDV. Additionally by using ADV it may take longer to find a valid route since only partial topology is maintained. Finally, ADV doesn't solve the problem of route churn and route entries may still be falsely removed.

### SUMMARY

It is the object of the present invention to obviate at least some of the above disadvantages and provide an improved method of adjusting a routing table update interval for use in a node of an ad-hoc radio telecommunications network.

Accordingly, the invention seeks to preferably mitigate, alleviate or eliminate one or more of the disadvantages mentioned above singly or in any combination.

According to a first aspect of the present invention there is provided a method of adjusting a routing table update interval in a node of an ad-hoc radio telecommunications network. The method comprises reducing said routing table update interval by dividing it by a first constant value if a local change in the network is detected by said node. A rate of routing table exchange is increased by a second constant value if a remote change in the network is detected by said node, wherein the rate of routing table exchange is reciprocal of the routing table update interval. Additionally, the rate of routing table exchange is reduced by the second constant value if no network change is detected by said node.

Preferably the method comprises increasing a counter of local change events upon receiving notification about a local change event and increasing a counter of remote change events upon receiving notification about a remote change event. The routing table update interval is reduced by dividing said interval by the first constant value if the local change event counter increased its value compared to its value in the previous cycle of routing table update and a speed of change of the local change events counter is increasing (accelerates). The rate of routing table exchanges is increased by the second constant value if there is no increase in the value of the local change event counter compared to its value in the previous cycle, and there is an increase in the value of the remote change event counter compared to its value in said previous cycle. The rate of routing table exchanges is reduced by said second constant value if there is no increase in the values of the local change event counter and the remote change event counter compared to their values in said previous cycle.

The invention allows for updating either all records of said routing table in one update, which is called a full update, or only part of them, so called partial update, which means that in said update only the changed records of said routing table are updated.

According to a second aspect of the present invention there is provided a node for an ad-hoc radio telecommunications network, which comprises a plurality of nodes. Said node comprises an event monitor for receiving event notifications from the network, a counter of local change events and a counter of remote change events. Said event monitor is adapted to increase said counter of local change events upon receiving notification about a local change and to increase said counter of remote change events upon receiving notification about a remote change. The node further comprises a routing table and a controller adapted to reduce a routing table update interval. The interval is reduced by dividing it by a first constant value if the local change event counter increased its value compared to its value in the previous cycle of the routing table update and a speed of change of the local change events counter is increasing. The controller is also adapted to increase the rate of routing table exchanges by a second constant value if the following two conditions are met: there is no increase in the value of the local change event counter compared to its value in the previous cycle of routing table update, and there is an increase in the value of the remote change event counter compared to its value in said previous cycle. The controller is also adapted to reduce the rate of routing table exchanges by said second constant value if there is no increase in the value of the counters compared to their values in said previous cycle.

The event monitor receives event notifications from a route daemon that monitors internal state repositories (i.e. neighbouring tables and routing tables) or from other nodes in the network.

According to a third aspect of the present invention there is provided an ad-hoc radio telecommunications network comprising a plurality of nodes and at least part of the nodes of said network are in accordance with the second aspect of the present invention.

Further features of the present invention are as claimed in the dependent claims.

The present invention has the following advantages:

Improved Route Convergence: whenever a link gets broken, the nodes of the link reduce the route update interval aggressively so that the change could be advertised to their neighbours quickly. Other nodes in the networks detect this change through monitoring their routing tables, and reduce the route update interval gradually and this approach reduces the overall number of updates exchanged and it is ensured that in the area of the network most affected by the event the update will be propagated quickly.

Fish-eye property: the nodes keep their neighbouring nodes updated more frequently than the remote nodes (i.e. Fish-Eye property). This significantly reduces the amount of control traffic overhead.

Route churn reduction: route time-out interval is increased gradually in a stable network, so that route entries are not removed falsely.

### BRIEF DESCRIPTION OF THE DRAWINGS

The present invention will be understood and appreciated more fully from the following detailed description taken in conjunction with the drawings in which:

FIG. 1 is a diagram illustrating a method of adjusting a routing table update interval in a node of an ad-hoc radio telecommunications network in one embodiment of the present invention;

FIG. 2 is a diagram illustrating a method of increasing the values of the counters in a node of an ad-hoc radio telecommunications network in one embodiment of the present invention;

FIG. 3 is a diagram illustrating a method of adjusting a routing table update interval in a node of an ad-hoc radio telecommunications network in one embodiment of the present invention;

FIG. 4 is a pseudo-code illustrating a method of adjusting a routing table update interval in a node of an ad-hoc radio telecommunications network in one embodiment of the present invention;

FIG. 5 is a diagram illustrating a node for an ad-hoc radio telecommunications network in one embodiment of the present invention.

FIG. 6 is a diagram illustrating an ad-hoc radio telecommunications network in one embodiment of the present invention.

### DETAILED DESCRIPTION

The term routing table update interval herein below refers to the period between two consecutive exchanges of the routing table by a network node with its neighbouring nodes.

The term route expiration interval herein below refers to the period between entering a new entry or refreshing an existing one in a routing table and expiration of said route entry, which is then removed if not refreshed.

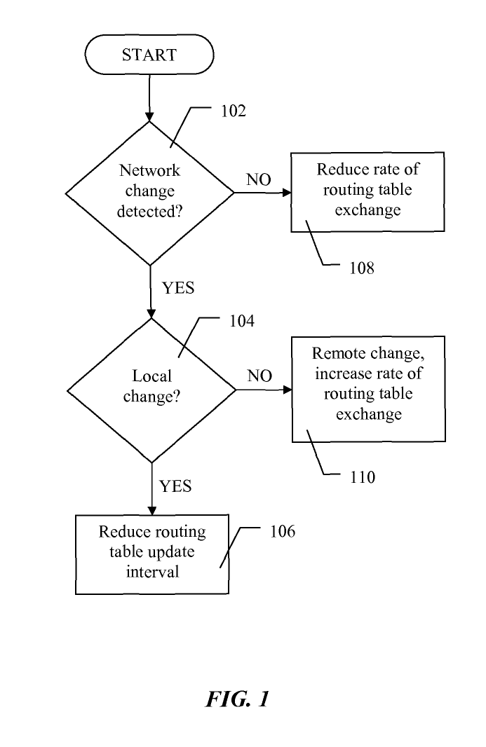

With reference to FIG. 1 and FIG. 6 an embodiment of a method of adjusting a routing table update interval in a node of an ad-hoc radio telecommunications network 600 is presented. In this embodiment a routing table update interval (RTUI) is adjusted automatically based on network conditions. In this update of the routing table all records of are updated, which means this is a full update. The routing table update interval is reduced aggressively, 106, if a local change in the network is detected 104 by said node. The purpose of this aggressive reduction of RTUI is to have the routing table updated as quickly as possible. To achieve such an aggressive reduction the length of the interval (RTUI) is divided by a first constant value, alfa and alfa>1. In one embodiment alfa=2, however other values of alfa are also possible.

In an alternative embodiment only part of the records is updated, so called partial update, which means that in said update only the changed records of said routing table are updated.

One example of a node in such an ad-hoc radio telecommunications network is a radio base station, a WIFI access point, a mobile phone or a WIFI based laptop, which runs a distance-vector routing protocol.

The routing table update interval is reduced gradually in the case of remote changes, which means that if a remote change in the network is detected 104 by said node a rate of routing table exchange is increased 110 by a second constant value, beta. The rate of routing table exchange is reciprocal of the routing table update interval. If f denote the rate of routing table exchange then

f=1/RTUI

In one embodiment beta=0.02, however other values of beta are also possible. This gradual reduction of routing table update interval facilitates the change advertisement and enhances route convergence.

The routing table update interval is increased gradually when there are no link changes or route changes, which means that if no change in the network is detected 102 by said node then the rate of routing table exchange is reduced 108 by the factor beta. This gradual increase of RTUI (i.e. reduction of the rate of routing table exchange) helps reducing unnecessary control traffic in the network and occurs in a stable network (when nodes are set-up and not removed or moved).

Essentially, the algorithm in this invention is feedback based. The protocol behaviour (i.e. parameters) are adjusted according to the network conditions including route availability and packet loss rate in order to achieve better performance without introducing too much control overhead.

The present invention determines network changes through monitoring internal state repositories (i.e. neighbouring tables and routing tables). And the rate f of routing table exchanges is multiplied by a factor alpha (alpha>1) if the link change rate is accelerated. The rate f of routing table exchanges is incremented by a factor beta if the route change rate is increased. Otherwise, the rate f of routing table exchanges is decremented by the factor beta.

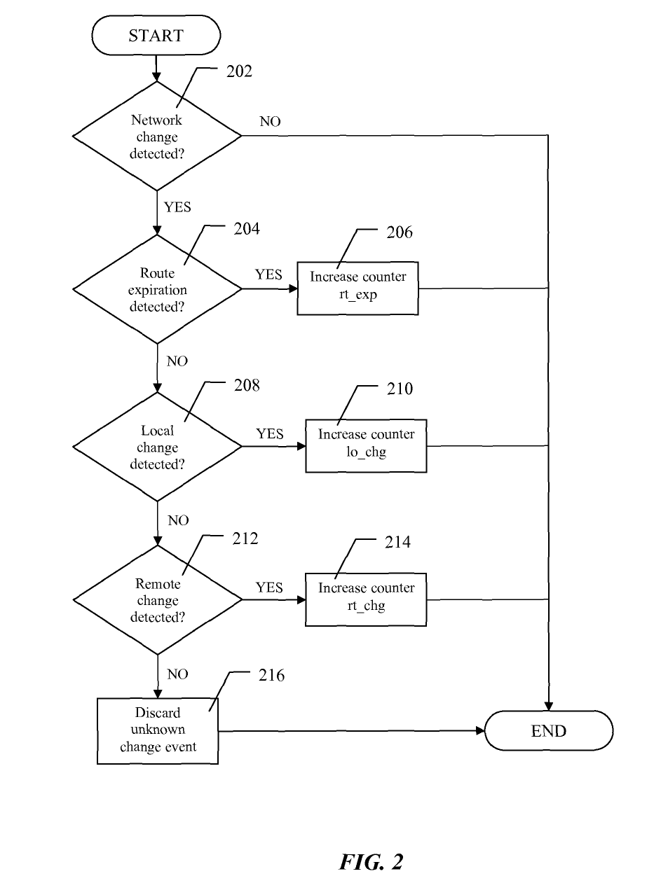

With reference to FIG. 2-FIG. 5 further embodiments of the present invention will be discussed in details.

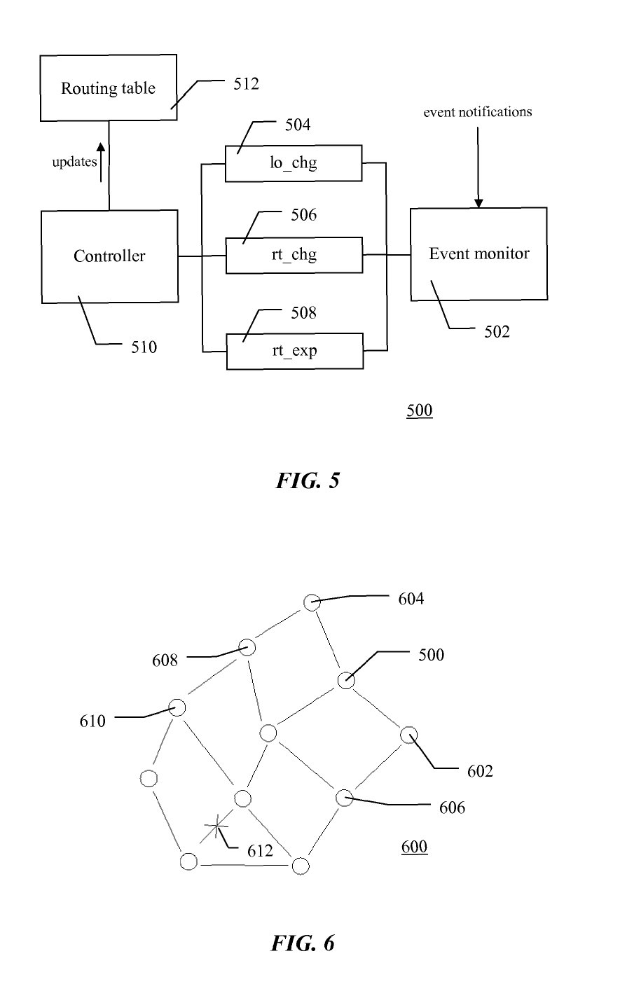

A network node 500, illustrated in FIG. 5 in one embodiment of the present invention comprises an event monitor 502, a counter of local change events 504, a counter of remote change events 506, a controller 510 and a routing table 512.

The event monitor 502 receives event notifications from a route daemon that monitors internal state repositories (i.e. neighbouring tables and routing tables) or from other nodes in the network. The event monitor 502, using the route daemon, monitors the following events as local change events: a feedback from link layer (including packet sending failure), and a route lookup failure. Let lo_chg be the number of the local change events or value of the counter of local change events 504.

Feedback from link layer. The feedback from link layer (including packet sending failure) contains information about the status of a link, including link quality, link breakage and link establishment. Upon receiving a notification from link layer, the route daemon increases lo_chg by 1.

Route lookup failure. When a node A receives a data packet whose destination is not A, it looks up its routing table to find the next-hop node for the packet. If there is no route found, a route lookup failure occurs. Such failure is caused by route inconsistency between the routing tables of the different nodes. Upon a failure of a route lookup for a destination node, the route daemon of said event monitor 502 increases lo_chg by 1.

The event monitor 502, using a route daemon monitors changes in routing tables as remote change events.

Changes in routing tables. When receiving a routing table from a neighbouring node, the event monitor 502 stores a copy of its own routing table before making updates. After route updates, the route daemon compares the latest routing table with its old one to find out the changes. There are two types of route changes, either caused by neighbour changes that occurs locally (when a new neighbour joins, at least a new route entry will be added into the routing table, when an existing neighbour leaves, at least one route entry to this neighbour will be deleted); or node changes that occurs remotely.

Let rt_chg be the number of remote changes or value of the counter of remote change events 506. For each remote change, the route daemon of the event monitor 502 increases rt_chg by 1.

In a preferred embodiment, additionally route expiration is monitored as a remote change event. There are two causes for route expiration. The route may still be valid but an update of the route entry fails (as explained in the route churn problem of DSDV). The other possibility is that the route is not valid any more because of node mobility or failure. This invention solves the problem of route churn by monitoring the route expiration events. The controller 510 increases the route expiration interval if any route expired during previous cycle of routing table update 304 and an increase of the counter of remote changes 506 is below a second predefined value 306, which in one embodiment of the present invention is one third of the routing table size. Monitoring of route expiration events is carried out by maintaining a route expiration counter 508 and increasing its value rt_exp by 1 upon expiration of a route. Once the event monitor 502 detects such route expiration the route daemon sends a signal to increase the rt_exp value by 1.

In alternative embodiments other values of increments applied to the counters can be used.

The present invention tunes the routing table update interval. As explained earlier, the rate of routing table exchanges f is

f=1/RTUI

Therefore, in order to increase the rate of routing table exchange the routing table update interval must be reduced. In one embodiment of the present invention the reduction of RTUI is achieved by dividing it by the constant value alfa=2.

RTUI_{new}=RTUI/alpha

where RTUI is the present value of the routing table update interval, RTUI_{new} is the modified value of the routing table update interval as a result of local change event and alfa is a constant value, alfa>1. In one embodiment alfa=2.

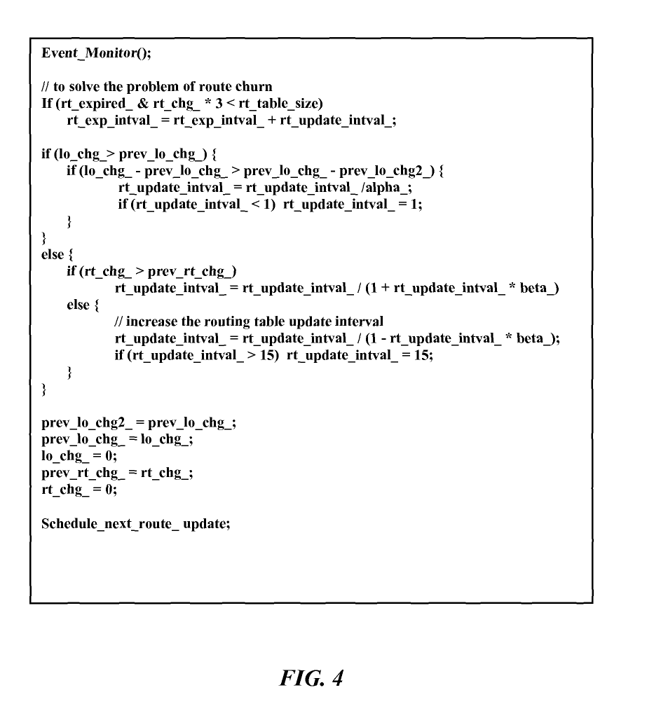

One embodiment of the present invention is presented in FIG. 4 in form of a pseudo code.

(a) When there is an increase in local change events (cf. line 7) and the speed of the change events increases (i.e. accelerates; cf. line 8), the route daemon of the event monitor 502 reduces the routing table update interval aggressively, i.e. divides it by alfa, which in one embodiment means it is halved (cf. line 9). This leads to a sharp increase of rate of routing table exchange. In the embodiment illustrated in FIG. 4 the (default) minimal routing table update interval is 1 s, which is configurable (cf. line 10).

(b) If there is no increase in local change events, but there is an increase in routing table changes, the rate of routing table exchanges is incremented by the factor beta (cf. lines 13-15).

(c) Otherwise, the rate of routing table exchanges is decremented by the factor beta in order to reduce unnecessary route update traffic (cf. lines 16-18). In this embodiment the default maximal routing table update interval is set to be 15 s, which is configurable (cf. line 19).

(d) In a preferred embodiment also route expiration is monitored and route expiration interval is adjusted. If any route entry expired during the previous update interval and there are only few route changes in the routing tables (i.e. rt_chg_{—}*3<rt_table_size), the route daemon of the event monitor 502 increases the route expiration interval by the routing table update interval (cf. lines 2 and 3). Since the routing table entries expire while the network is relatively stable, increasing route expiration intervals helps releasing the route expiration and reduce route churn. This means that the route expiration interval is increased gradually if there are not enough route changes detected.

With reference to FIG. 2 a change detection used in one embodiment of the present invention is illustrated.

The operation starts with detection of a change 202 in the network. For the purpose of this invention three types of network changes were discussed earlier: local changes, remote changes and route expirations. Detection and processing of route expiration events is optional and is presented in a preferred embodiment of this invention. Alternative embodiments of the present invention may not contain the feature of detecting route expiration and changing operation of the network in response to route expiration event.

If the detected event is a route expiration 204 the event monitor 502 increases 206 value of the route expiration counter 508 (rt_exp) by 1.

In case of detection of local change 208 the event monitor 502 increases 210 the local counter 504 (lo_chg) by 1.

If the change event relates to a remote change, 212, then remote change event counter 506 (rt_chg) is increased by 1.

If the event monitor 502 detects a change that does not belong to any of these three groups, said change is discarded, 216, as unknown.

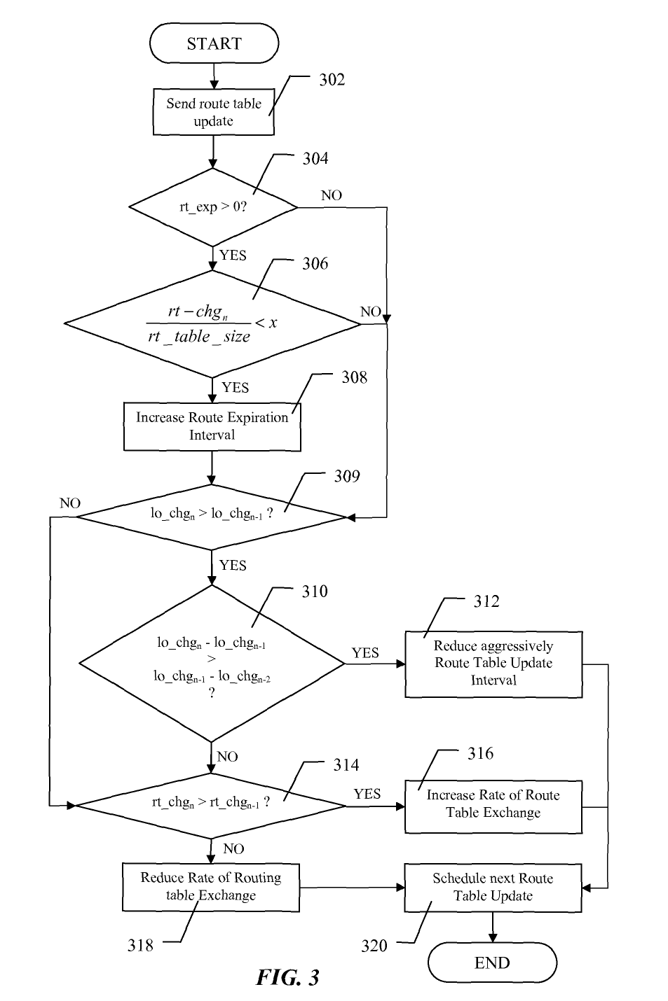

The operations of increasing counters 504, 506, 508 are performed during the period between two consecutive routing table updates. As a result of detection of said events and changing values of the counters the routing table update interval and, in a preferred embodiment, the route expiration interval are adjusted. Adjusting routing table interval and route expiration interval is carried out after sending routing table update 302, which is illustrated in FIG. 3.

In a preferred embodiment, in the node 500 route expiration counter 508 is maintained and increased upon route expiration. If the route expiration counter 508 increased its value compared to the previous cycle of routing table update, 304, and an increase of the counter of remote changes is less than one third the size of the routing table (a second predefined value), 306, the route expiration interval is increased 308 by a value of the routing table update interval (a first predefined value).

It is, however, within contemplation of the present invention that both, the first and the second predefined values can have values different from the ones given in the embodiment above.

In the next steps it is checked if the local change event counter increased its value compared to its value in the previous cycle of routing table update, 309, and if the rate of change of the counter of the local change events 504 increases, 310. If the answer is “yes” then the routing table update interval is reduced aggressively, 312, by a controller 510. In one embodiment the routing table update interval is divided by 2. If the rate of increase of value of the counter of local change events does not accelerate it is checked by the controller 510 if the counter of remote change events 506 increased since the previous cycle, 314. If this is confirmed, then, in one embodiment, the controller 510 increases, 316, the rate of routing table exchange by 0.02. If there is no remote and local change and the counters of remote and local change events did not change their values then the rate of routing table exchange is reduced, 318, by 0.02. Once this cycle is closed a next routing table update is scheduled, 320.

The overall benefit of this invention is that it improves route convergence and route stability without introducing a significant increase in control overhead.

FIG. 6 illustrates an ad-hoc radio telecommunications network 600 comprising a plurality of nodes 500, 602-610. In one embodiment at least part of said nodes comprise the elements of node 500 that enable them to operate according to the method of the present invention. As explained, in an ad-hoc telecommunications network some nodes are removed or moved to another location, or some links between nodes can be removed or broken, 612, which requires efficient updating of routing table as discussed in the embodiments of the present invention.

1. A method of adjusting a routing table update interval in a node of an ad-hoc radio telecommunications network, the method comprising: reducing said routing table update interval by dividing it by a first constant value if a local change in the network is detected by said node; increasing a rate of routing table exchange by a second constant value if a remote change in the network is detected by said node, wherein the rate of routing table exchange is reciprocal of the routing table update interval; and reducing the rate of routing table exchange by the second constant value if no network change is detected by said node.

2. The method according to claim 1 comprising:
a) increasing a counter of local change events upon receiving notification about a local change event;
b) increasing a counter of remote change events upon receiving notification about a remote change event;
c) reducing the routing table update interval by dividing the routing table update interval by the first constant value if the local change event counter increased its value compared to its value in the previous cycle of routing table update and a speed of change of the local change events counter is increasing;
d) increasing the rate of routing table exchanges by the second constant value if there is no increase in the value of the local change event counter compared to its value in the previous cycle of routing table update, and there is an increase in the value of the remote change event counter compared to its value in said previous cycle; and
e) reducing the rate of routing table exchanges by said second constant value if there is no increase in the value of the local change event counter compared to its value in the previous cycle of routing table update, and there is no increase in the value of the remote change event counter compared to its value in said previous cycle.

3. The method according to claim 2 further comprising increasing a route expiration interval by a first predefined value if any route expired during previous cycle of routing table update and an increase of the counter of remote changes is below a second predefined value.

4. The method according to claim 2, wherein said counter of local change events is increased upon receiving notification from a link layer about link quality change or link breakage, or link establishment.

5. The method according to claim 2, wherein said counter of remote change events is increased upon receiving notification about route expiration or about a change in a routing table.

6. The method according to claim 3, wherein said first predefined value is equal to the routing table update interval.

7. The method according to claim 1, wherein said method is performed independently by an individual node of said network.

8. The method according to claim 1, wherein in said update all records of said routing table are updated.

9. A node for an ad-hoc radio telecommunications network comprising a plurality of nodes, said node comprising an event monitor for receiving event notifications from the network, a counter of local change events, a counter of remote change events, wherein said event monitor is adapted to increase said counter of local change events upon receiving notification about a local change and to increase said counter of remote change events upon receiving notification about a remote change; the node further comprises a routing table and a controller adapted to reduce a routing table update interval of said routing table by dividing the routing table update interval by a first constant value if the local change event counter increased its value compared to its value in the previous cycle of the routing table update and a speed of change of the local change events counter is increasing; to increase the rate of routing table exchanges by a second constant value if there is no increase in the value of the local change event counter compared to its value in the previous cycle of routing table update, and there is an increase in the value of the remote change event counter compared to its value in said previous cycle; and to reduce the rate of routing table exchanges by said second constant value if there is no increase in the value of the counters compared to their values in said previous cycle.

10. The node according to claim 9 further comprising a route expiration counter and said event monitor is adapted to increase said route expiration counter upon receiving notification about route expiration and the controller is adapted to increase a route expiration interval by a first predefined value if any route expired during previous cycle of routing table update and an increase of the counter of remote changes is below a second predefined value.

11. The node according to claim 9, wherein said event monitor is adapted to increase the counter of local change events in response to reception of a notification from a link layer about link quality change or link breakage, or link establishment.

12. The node according to claim 9, wherein said event monitor is adapted to increase the counter of remote change events in response to reception of a notification about route expiration or about a change in a routing table.

13. The node according to claim 10, wherein said first predefined value is equal to the routing table update interval.

14. An ad-hoc radio telecommunications network comprising a plurality of nodes including at least one node in accordance with claim 9.
